(19) United States
(12) Patent Application Publication
(10) Pub. No.: US 2013/0262736 A1
(43) Pub. Date: Oct. 3, 2013

(54) MEMORY TYPES FOR CACHING POLICIES

(71) Applicants: Andrew KEGEL, Redmond, WA (US); Mark Hummel, Franklin, MA (US); Anthony Asaro, Ontario (CA)

(72) Inventors: Andrew KEGEL, Redmond, WA (US); Mark Hummel, Franklin, MA (US); Anthony Asaro, Ontario (CA)

(73) Assignees: ATI Technologies ULC, Ontario (CA); Advanced Micro Devices, Inc., Sunnyvlae, CA (US)

(21) Appl. No.: 13/436,342

(22) Filed: Mar. 30, 2012

(51) Int. Cl. G06F 12/10; G06F 12/08

(52) U.S. Cl. 711/3; 711/E12.017; 711/E12.058

(57) ABSTRACT

The present system enables receiving a request from an I/O device to translate a virtual address to a physical address to access the page in system memory. One or more memory attributes of the page defining a cacheability characteristic of the page is identified. A response including the physical address and the cacheability characteristic of the page is sent to the I/O device.

### BACKGROUND

1. Field of the Invention

The present invention is generally directed to computing systems. More particularly, the present invention is directed to sharing memory attributes of a page within a computing system.

2. Background Art

The desire to use a graphics processing unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market (e.g., notebooks, mobile smart phones, tablets, etc.) and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available primarily for the acceleration of graphics. These constraints arose from the fact that GPUs did not have as rich a programming ecosystem as CPUs. Their use, therefore, has been mostly limited to two-dimensional (2D) and three-dimensional (3D) graphics and, recently, a select few leading edge multimedia applications written by programmers who are already accustomed to dealing with graphics and video application programming interfaces (APIs).

With the advent of multi-vendor supported OpenCL® and DirectCompute®, standard APIs and supporting tools, the limitations of the GPUs in traditional applications has been extended beyond traditional graphics. Although OpenCL and DirectCompute are a promising start, there are many hurdles remaining to creating an environment and ecosystem that allows the combination of a CPU and a GPU to be programmed as easily as the CPU for most programming tasks.

Existing computing systems often include multiple processing devices. For example, some computing systems include both a CPU and a GPU on separate chips (e.g., the CPU might be located on a motherboard and the GPU might be located on a graphics card) or in a single chip package. Both of these arrangements, however, still include significant challenges associated with (i) efficient scheduling of software tasks or “kernels”, (ii) providing quality of service (QoS) guarantees between processes, (iii) programming model, (iv) compiling to multiple target instruction set architectures (ISAs), and (v) separate memory systems—all while minimizing power consumption.

However, in the existing multi-processing computing systems, programmers are faced with significant constraints. For example, in these existing systems, programmers are required to marshal memory between separate address spaces when separate client devices require use of the separate memory systems.

### SUMMARY OF THE EMBODIMENTS

Therefore, what is needed is a technique to free programmers from the above noted constraints in multi-processing computing systems.

Although GPUs, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner with respect to resources such as conventional CPUs, conventional GPUs, and/or combinations thereof.

Embodiments of the present invention provide, under certain circumstances, methods for sending a plurality of memory attributes of a page in system memory to an input/output (I/O) device or an APD. In one embodiment, a request is received from an I/O device or APD to translate a virtual address to a physical address which is then used to access a page in system memory. One or more memory attributes of the page defining a cacheability characteristic of the page is identified. A response including the physical address and the identified one or more memory attributes of the page is sent to the I/O device. Using the cacheability characteristic allows hardware to efficiently optimize APD memory accesses to improve performance.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1 is an illustrative block diagram of a processing system in accordance with an embodiment of the present invention.

FIG. 2 is an exemplary block diagram of nested address spaces according to an embodiment of the present invention.

FIG. 3 is an exemplary block diagram of host page tables including one or more memory attributes shared between a processor and an IOMMU in accordance with an embodiment of the present invention.

FIG. 4 is an illustration of a table including cacheability characteristics in accordance with an embodiment of the present invention.

FIG. 5 is an illustration of a 4-Kbyte page table entry format including memory attribute information in accordance with an embodiment of the present invention.

FIG. 6 is an illustration of a PAT register format in accordance with an embodiment of the present invention.

FIG. 7 is an illustration of an exemplary method of practicing an embodiment of the present invention.

### DETAILED DESCRIPTION OF THE EMBODIMENTS

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

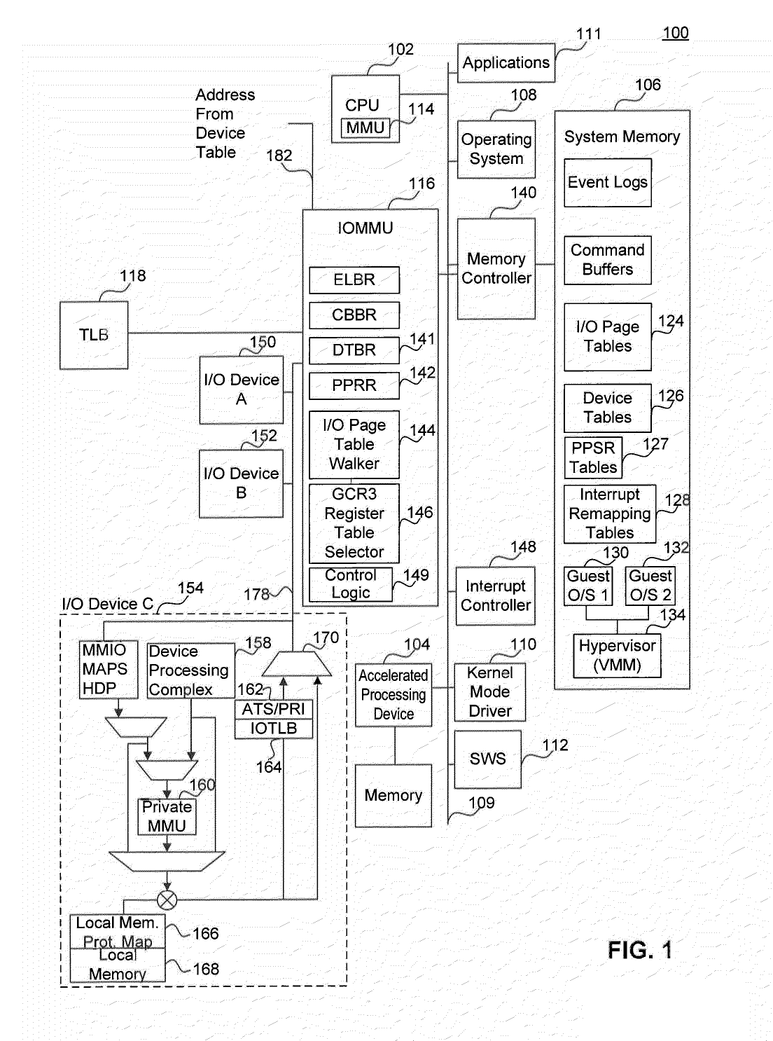

FIG. 1 is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining CPU 102 and APD 104 and some supporting components to provide a unified programming and execution environment. This environment enables the APD 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a system memory 106, an operating system 108, and a communication infrastructure 109. Access to memory 106 can be managed by a memory controller 140, which is coupled to system memory 106. For example, requests from CPU 102, or from other devices, for reading from or for writing to system memory 106 are managed by the memory controller 140. The operating system 108 and the communication infrastructure 109 are discussed in greater detail below.

The system 100 also includes a kernel mode driver (KMD) 110, a software scheduler (SWS) 112, and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1.

In one example, a driver, such as KMD 110, typically communicates with a device through a computer bus or communication infrastructure 109 to which the hardware connects. When a calling program invokes a routine in the driver, the driver issues commands to the device. Once the device sends data back to the driver, the driver may invoke routines in the original calling program. In one example, drivers are hardware-dependent and operating-system-specific. They usually provide the interrupt handling required for any necessary asynchronous time-dependent hardware interface.

CPU 102 can include (not shown) one or more of a control processor, field programmable gate array (FPGA), application specific integrated circuit (ASIC), or digital signal processor (DSP). CPU 102, for example, executes the control logic, including the operating system 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102.

For example, commands can be considered as special instructions that are not typically defined in the ISA and in some embodiments commands may be implemented as sets of ISA instructions to be executed as a group on APD 104 compute unit. A command may be executed by a special processor such a dispatch processor, command processor, or network controller. On the other hand, instructions can be considered, for example, a single operation of a processor within a computer architecture. In one example, in software such as Application 111 or operating system 108 that use two sets of ISAs, some instructions are used to execute x86 programs on CPU 102 and some instructions or commands are used to execute kernels on an APD 104 compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command or instruction.

Having one or more SIMDs, in general, makes APD 104 ideally suited for execution of data-parallel tasks such as those that are common in graphics processing.

Referring back to the example shown in FIG. 1, IOMMU 116 includes logic to perform virtual-to-physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in memory 106.

In the example shown, communication infrastructure 109 interconnects the components of system 100 as needed. Communication infrastructure 109 includes the functionality to interconnect components including components of computing system 100.

In this example, operating system (OS) 108 includes functionality to manage the hardware components of system 100 and to provide common services. In various embodiments, OS 108 can execute on CPU 102 and provide common services. These common services can include, for example, scheduling applications for execution within CPU 102, fault management, interrupt service, as well as processing the input and output of other applications.

In some embodiments, based on interrupts generated by an interrupt controller, such as interrupt controller 148, OS 108 invokes an appropriate interrupt-handling routine. For example, upon detecting a page fault interrupt, OS 108 may invoke an interrupt handler to initiate loading of the relevant page into memory 106 and to update corresponding page tables.

A person of skill in the art will understand, upon reading this description, that computing system 100 can include more or fewer components than shown in FIG. 1. For example, computing system 100 can include one or more input interfaces, non-volatile storage, one or more output interfaces, network interfaces, and one or more displays or display interfaces.

FIG. 1 further illustrates a memory mapping structure configured to operate between the system memory 106, the IOMMU 116, and the I/O devices A, B, and C, represented by numerals 150, 152 and 154, respectively, connected via communications infrastructure 178 (which in the exemplary embodiment is illustrated as a bus but other communication fabrics could alternatively be employed). IOMMUs, such as the IOMMU 116, can be hardware devices that operate to translate direct memory access (DMA) virtual addresses into system physical addresses. Generally, IOMMUs such as the IOMMU 116 construct one or more unique address spaces and use the unique address space(s) to control how a device's DMA operation accesses memory. While FIG. 1 only shows one IOMMU for sake of example, embodiments of the present invention can include more than one IOMMU.

Generally, an IOMMU can be connected to its own respective bus and I/O device(s). In FIG. 1, a communications infrastructure 109 may be any type of bus used in computer systems, including a PCI bus, an AGP bus, a PCI-E bus (which is more accurately a point-to-point interconnect), or any other type of bus or communications channel whether presently available or developed in the future. Communications infrastructure 109 may further interconnect interrupt controller 148, KMD 110, SWS 112, applications 111, and OS 108 with other components in system 100.

The I/O devices which may be connected to IOMMU 116 are further illustrated in FIG. 1. The I/O devices interfacing architecture includes I/O devices A, B, and C, represented by element numbers 150, 152, and 154. The I/O device C also includes device processing complex 158, private MMU 160, IOTLB 164, address translation service (ATS)/peripheral request interface (PRI) request block 162, local memory 168, local memory protection map 166, and multiplexer 170.

The I/O devices A, B and C are representative of many types of I/O devices including but not limited to APDs, expansion cards, peripheral cards, network interface controller (NIC) cards with extensive off-load capabilities, WAN interface cards, voice interface cards, and network monitoring cards. More than one I/O device may be connected to each IOMMU through various bus configurations.

The system 100 illustrates high level functionality of the system, and the actual physical implementation may take many forms. For example, the MMU 114 is commonly integrated into each processor 102.

Alternatively, any other coherent interconnect may be used between processor 102's nodes and/or any other I/O interconnect may be used between processor nodes and the I/O devices. Furthermore, another example may include processor 102 coupled to a northbridge, which is further coupled to system memory 106 and one or more I/O interconnects, in a traditional PC design.

Any of I/O devices 150, 152 and 154 may issue a DMA operation that flows upwards through the IOMMU 116 where the DMA operation gets processed. Then the flow may continue to the Memory Controller 140.

At the time of connection of an I/O device, if the IOMMU 116 is detected, software initiates a process of establishing the necessary control and data structures. For example, when IOMMU 116 is set up, the IOMMU 116 can include device table base register (DTBR) 141, control logic 149, and peripheral page request register (PPRR) 142. Further, during initial set-up, the IOMMU 116 can include a guest control register table selector 146 for selecting the appropriate guest page table's base pointer register table. The base pointer register table can be, for example, pointed to by a control register 3 (CR3) which is used by an x86 microprocessor process to translate physical addresses from virtual addresses by locating both the page directory and page tables for current tasks.

A guest CR3 (GCR3) change can establish a new set of translations and therefore the processor invalidates TLB 118 entries associated with the previous context. The GCR3 register may be used by I/O page table walker 144.

Also, the IOMMU 116 can be associated with one or more TLBs 118 for caching address translations that are used for fulfilling subsequent translations without needing to perform a page table walk. Addresses from a device table can be communicated to IOMMU 116 via bus 182.

Once the data structures are set up, the IOMMU 116 may begin to control DMA operation access, interrupt remapping, and address translation.

As illustrated in FIG. 1, the IOMMU 116 is connected between the system memory 106 and the I/O devices 150, 152, and 154. Further, the IOMMU 116 can be located on a separate chip from the system memory 106, memory controller 140, and I/O devices 150, 152, and 154. The IOMMU 116 may be designed to manage major system resources and can use I/O page tables 124 to provide permission checking, address translation on memory accessed by I/O devices, and cacheability characteristics of a page in system memory. One or more attributes of the page in the memory may define a cacheability characteristic of the page. Also, I/O page tables may be designed in the AMD64 Long format. The device tables 126 allow I/O devices to be assigned to specific domains. The device tables 126 also may be configured to include pointers to the I/O devices' page tables.

IOMMU 116 can be configured to thwart malicious DMA requests as a security and permission checking measure by remapping the unpermitted DMA requests. Further, regarding interrupt remapping, IOMMU 116 can also be configured to (i) redirect interrupt requests to the correct memory locations and (ii) redirect interrupt requests to the correct virtual or physical CPUs running the guest VMs. The IOMMU 116 also efficiently manages secure direct assignment of I/O devices. The IOMMU 116 further uses interrupt remapping tables 128 to provide permission checking and interrupt remapping for I/O device interrupts.

The IOMMU 116 supports the delivery of interrupts directly to one or more concurrently running guests (e.g. guest VMs) without hypervisor intervention. In other words, the IOMMU 116 can provide translation services without the need of hypervisor 134. An exemplary IOMMU 116 signals interrupts using standard PCI INTx, MSI, or MSI-X interrupts.

System 100 also includes system memory 106, which includes additional memory blocks (not shown). A memory controller 140 can be on a separate chip or can be integrated in the processor 102 silicon. System memory 106 is configured such that DMA and processor activity communicate with memory controller 140.

System memory 106 includes I/O page tables 124, device tables 126, interrupt remapping table (IRT) 128, and a software module such as hypervisor 134. System memory 106 can also include one or more guest OSs running concurrently, such as guest OS 1, represented by numeral 130, and guest OS 2 (132). Hypervisor 134 is a software construct that works to virtualize the system in order to run guest OSs 130 and 132.

The guest OSs, such as guest OS 130 and guest OS 132, are more directly connected to I/O devices such as I/O devices 150, 152, and 154 in the system 100 because the IOMMU 116, a hardware device, is permitted to do the work that the hypervisor 134, under traditional approaches, would otherwise have to do.

Further, the IOMMU 116 and the system memory 106 may be initialized such that DTBR 141 points to the starting index of device tables 126. Further, PPRR 142 points to the starting index of peripheral page service request (PPSR) tables 127.

The IOMMU 116 uses memory-based queues for exchanging command and status information between the IOMMU 116 and the system processor(s), such as CPU 102. Also, each IOMMU 116 may implement an I/O page service request queue.

When enabled, the IOMMU 116 intercepts requests arriving from downstream devices (which may be communicated using Communications infrastructure 109, for example, HyperTransport™ link or PCI-based communications), performs permission checks, performs address translation on the requests, identifies caching characteristics of the page, and sends translated versions upstream via the Communications infrastructure 109 to system memory 106 space. Other requests may be passed through IOMMU 116 unaltered.

The IOMMU 116 can read from tables in system memory 106 to perform its permission checks, interrupt remapping, address translations, and identify caching characteristics of a page. To ensure deadlock free operation, memory accesses for device tables 126, I/O page tables 124, and interrupt remapping tables 128 by the IOMMU 116 use an isochronous virtual channel and may only reference addresses in system memory 106. Other memory reads originated by the IOMMU 116 can use the normal virtual channel.

System performance may be substantially diminished if the IOMMU 116 performs the full table lookup process for every device request it handles. Implementations of the IOMMU 116 are therefore expected to maintain internal caches such as TLB 118 for the contents of the IOMMU 116's in-memory tables. During operation, IOMMU 116 requires system software to send appropriate invalidation commands as system software updates table entries that were cached by the IOMMU 116.

The IOMMU 116 can write to a peripheral page service request queue 127 in system memory 106. Writes to a peripheral page service request queue 127 in memory can use the normal virtual channel.

The IOMMU 116 may provide for a request queue in memory to service peripheral page requests while the system processor CPU 102 uses a fault mechanism. Any of I/O devices 150, 152, and 154 can request a translation from the IOMMU 116 and the IOMMU 116 may respond with a successful translation or with a page fault.

On the CPU 102, a page fault is caused when a program attempts to access a page that is not present in the system memory 106. The context of the instruction is saved by the CPU 102, the software is invoked to bring in the missing page from disk, and the program execution is resumed with the saved context. In this case, the software continues running as if nothing had happened.

In one embodiment, a terminal failure is caused on the I/O device 154 when it attempts to access a page that is not present in memory. In one embodiment, ATS/PRI 162 may define a method so that I/O device 154 can process page faults. In this embodiment, ATS/PRI 162 allows I/O device 154 to continue running when it accesses a page that is not present in memory. For example, in one embodiment of the present invention, I/O device 154 may request the translation information to be changed upon request. If I/O device 154 is an APD that requests translation information (e.g., caching state) about a page and the caching state is unsafe, the APD may use the ATS/PRI 162 mechanism to request the caching state be changed to a safe value.

When IOMMU 116 processes a device access to memory, IOMMU 116 looks up the device virtual address in its translation cache (TLB 118) and/or the appropriate I/O page tables to determine a caching state of the page in memory as well as the system physical address to access.

In embodiments of the present invention, the IOMMU 116 can support address translation for nested page tables, which are managed according to the page tables. Example translations are directly compatible with exemplary long page tables supporting 4K byte, 2M byte, and 1G byte pages.

The IOMMU 116 handles requests for memory access and is implemented such that memory protections permit the IOMMU 116 to share translation table data. This translation table data can include nested page table data used by the IOMMU 116 and/or MMU 114. The translation table data includes translation information such as, for example, address translation, access permission, and caching state.

The CPU 102 may cache a subset of the page tables (e.g., address translations) in MMU 114 to access address translations more quickly. In this way, the CPU 102 does not need to access the system memory 106 for an address translation. For example, if the CPU 102 executes program instructions, the instructions may reference memory so that a particular memory address is processed through the MMU 114. If the memory page were recently accessed, then the address translation may be present in the MMU 114 and the CPU 102 does not need to access the system memory 106 to obtain the address translation. If the address translation is not present in the MMU 114, then the CPU 102 walks the page tables. Walking the page tables may include issuing a sequence of memory reads that ultimately access I/O Page Tables 124 and storing that translation information in the MMU 114. The CPU 102 may identify in the page table address translation information, permission information, and caching state, and store these in the MMU 114. Thereafter, nearby addresses can be translated through that same set of page table information.

Similarly, TLB 118 reduces the performance penalty associated with page translation. TLBs 118 are special on-chip caches That hold virtual-to-physical address translations (e.g., the most-recently used) for the IOMMU 116. Address translations are described in further detail below. Each memory reference (instruction and data) may be checked by the TLB 118. If the translation is present in the TLB 118, the translation is immediately provided to the peripheral device, thus avoiding external memory references for accessing page tables. TLBs 118 take advantage of the principle of locality. That is, if a memory address is referenced, it is likely that nearby memory addresses will be referenced in the near future. In the context of paging, the proximity of memory addresses required for locality can be broad—it is equal to the page size. Thus, it is possible for a large number of addresses to be translated by a small number of page translations. This high degree of locality may increase the translations that are performed using the on-chip TLBs.

System software may be responsible for managing the TLBs 118 when updates are made to the virtual-to-physical mapping of addresses. A change to any paging data-structure entry may not be automatically reflected in the TLB 118, and hardware snooping of TLBs 118 during memory-reference cycles may not be performed. Software invalidates the TLB entry of a modified translation-table entry so that the change is reflected in subsequent address translations.

Host OSs may also perform translations for I/O device-initiated accesses. While the IOMMU 116 translates memory addresses accessed by I/O devices, a host OS may set up its own page tables by constructing I/O page tables that specify the desired translation. The host OS may make an entry in the device table pointing to the newly constructed I/O page tables and can notify the IOMMU of the newly updated device entry. At this point, the corresponding IOMMU I/O tables (e.g., from graphics or other I/O devices) and the host OS I/O tables may be mapped to the same tables.

Any changes the host OS performs on the page protection, translation, or caching state may be updated in both the processor I/O page tables and the memory I/O page tables.

The IOMMU 116 is configured to perform I/O tasks traditionally performed by exemplary hypervisor 134. This arrangement eliminates the need for hypervisor intervention for protection, isolation, interrupt remapping, and address translation. However, when page faults occur that cannot be handled by IOMMU 116, IOMMU 116 may request intervention by hypervisor 134 for resolution. However, once the conflict is resolved, the IOMMU 116 can continue with the original tasks, again without hypervisor intervention.

Hypervisor 134, also known as a virtual machine monitor (VMM), uses the nested translation layer to separate and isolate guest VMs 130 and 132. I/O devices such as I/O devices 150, 152 and 154 can be directly assigned to any of the concurrently running guest VMs such that I/O devices 150, 152 and 154 are contained to the memory space of any one of the respective VMs. Further, I/O devices, such as I/O devices 150, 152 and 154 are unable to corrupt or inspect memory or other I/O devices belonging to the hypervisor 134 or another VM. Within a guest VM, there is a kernel address space and several process (user) address spaces.

For the general architecture of such a device, reference is again made to FIG. 1, illustrating the system element CPU 102 and the IOMMU 116. Many parts of the I/O devices are optional so multiplexers are shown where functions may be by-passed. For example, an access to the system address space may either flow through an IOTLB 164 working with. an ATS/PRI unit 162, or it may flow directly to an IOMMU 116 for service. The device processing complex 158 may represent a general purpose APD, such as APD 104, I/O devices such as I/O devices 150, 152 and 154, or other specialized computational engine, as discussed herein.

In an embodiment of the present invention, data access can originate with the CPU 102 or with the device processing complex 158. Data access can terminate in a local memory access from local memory 168 or in a system access from system memory 106. In an exemplary implementation, IOTLB 164 functionality can be added that uses ATS for translation efficiency. PPR/PRI support can be added for advanced function and efficiency. The ATS/PRI advanced functionality is represented by element number 162. A peripheral may provide a private MMU such as private MMU 160 function for custom address translation and access control.

A page-translation mechanism (or simply paging mechanism) enables system software to create separate address spaces for each process or application. These address spaces can be referred to as virtual address spaces. System software uses the paging mechanism to selectively map individual pages of physical memory into the virtual address space using a set of hierarchical address-translation tables known collectively as page tables.

When paging is enabled, a memory access has its virtual address automatically translated into a physical address using the page-translation hierarchy. The paging mechanism and the page tables may be used to provide each process with its own private region of physical memory for storing its code and data. Processes can be protected from each other by isolating them within the virtual-address space. System software can use the paging mechanism to selectively map physical memory pages into multiple virtual address spaces. Mapping physical pages in this manner allows them to be shared by multiple processes and applications.

A page table is a table structure used to translate an address from one representation to an alternate representation. The CPU 102 and I/O Device 154 can share pages tables in the system memory 106. In one embodiment of the present invention, the host page tables include one or more memory attributes of a page that are shared between the CPU 102 and I/O Device 154 via the IOMMU 116.

In one embodiment, the IOMMU 116 uses a page table structure designed to support a full 64-bit device virtual address space. For example, the IOMMU page tables may be a generalization of AMD64 long mode page tables. In one embodiment, the IOMMU page tables are a multi-level tree of 4K tables indexed by groups of 9 virtual address bits (determined by the level within the tree) to obtain 8-byte entries. Each page table entry is either a page directory entry pointing to a lower-level 4K page table, or a page translation entry specifying a system physical page address.

The first generalization in the IOMMU page tables compared to processor page tables is that directory entries, in addition to specifying the address of the lower page table, also specify the level, or grouping of bits within the virtual address, that is used for the next page table lookup step. This allows the IOMMU to skip page translation steps in cases where the virtual address contains long strings of 0 bits, such as software architectures that allocate virtual memory sparsely. The second generalization in the IOMMU page tables is that page translation entries can specify the page size of the translation.

In one embodiment of the present invention, the I/O device 154 may interact with system memory 106 in a virtualized system via two-layer address translation provided by the IOMMU 116.

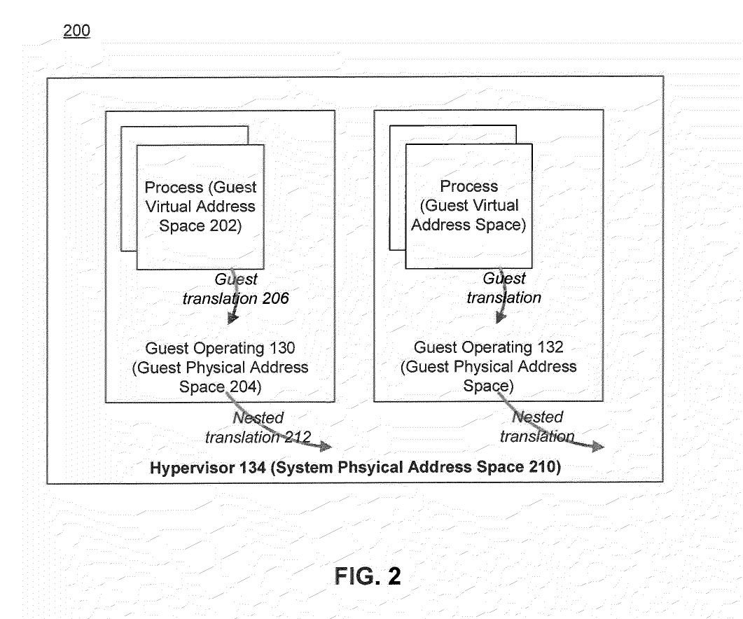

FIG. 2 is an exemplary block diagram of nested address spaces 200 according to an embodiment of the present invention.

A layered address translation may be viewed as nested address spaces as illustrated in FIG. 2. Each address space has a set of address translation tables. For example, the IOMMU 116 can provide translation from a guest virtual address (GVA) (within a guest virtual address space 202) to a guest physical address (GPA) (within a guest physical address space 204). The IOMMU guest translation 206 may be managed by guest operating system 130.

Further, the IOMMU 116 can also provide translation from a guest physical address to a system physical address (SPA) (within a system physical address space 210). The IOMMU nested translation 212 can be managed by the hypervisor 134. The system physical address can be used to access information in the system memory.

The guest page translation tables can be compatible with the format and semantics of the processor, including IOMMU updates to the Access and Dirty bits. The Access bit may indicate whether the page-translation table or the physical page to which the entry points has been accessed by the IOMMU or processor. The Dirty bit may indicate whether the page-translation table or the physical page to which this entry points has been written to by a peripheral.

When guest translation is used, the IOMMU follows the address translation requirements for guest virtual addresses and thus software may not be required to issue an invalidation command when it promotes or raises guest access privileges. When software demotes or reduces guest access privileges or removes the guest page (“present to not-present”), the software issues an invalidation. Therefore an ATS request or DMA reference that results in insufficient guest privileges calculated from a TLB entry may be based on stale information. To determine the cacheability characteristics of a page, the IOMMU may rewalk the guest page tables to identify the cacheability characteristics of the page using information read from memory. The nested page tables may be read as a consequence of the guest table rewalk. The IOMMU 116 determines the results of the access based on the newly read page table information. The rewalk may include performing a full walk of both guest and nested translations.

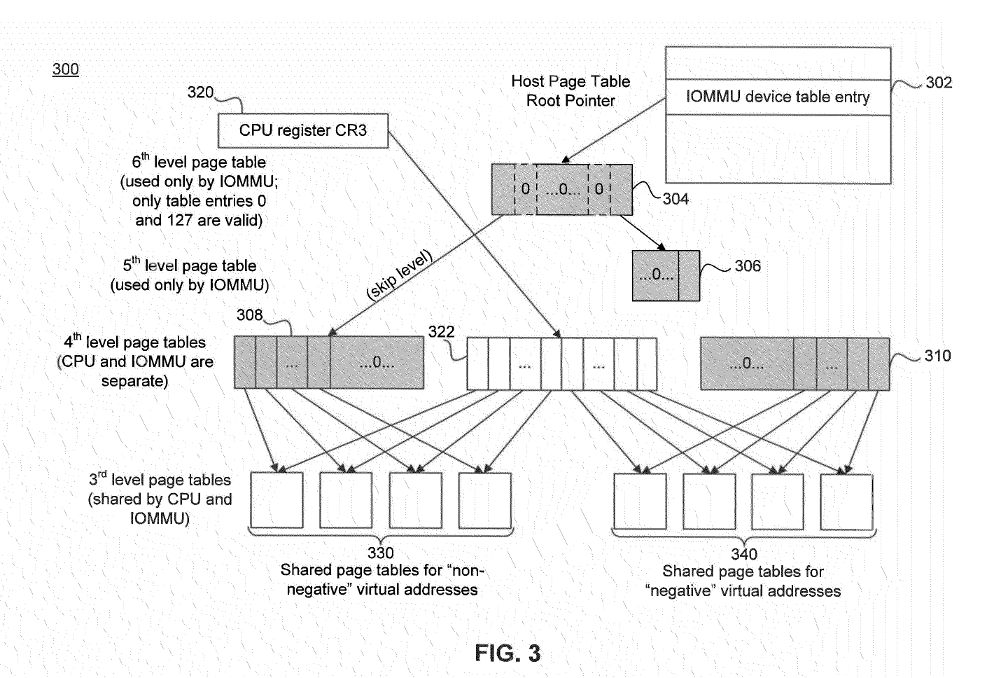

FIG. 3 is an exemplary block diagram of host page tables including one or more memory attributes shared between a processor and an IOMMU 300 in accordance with an embodiment of the present invention.

The I/O page table structures can be shared among processors and IOMMUs. The table structures (e.g., interrupt remapping table, device table, and host I/O page tables) can also be shared among IOMMUs. The guest I/O page table structures may be directly compatible with page table formats and the IOMMU may access and update the tables so they can be shared with a processor. Shared tables may have requirements for correct updates by system software. When updating a table entry, system software may use aligned 64-bit accesses.

In one embodiment, for the IOMMU 116 to directly share processor page tables, some fields (e.g., “Next Level” fields) in the page table entries are initialized with correct values for the IOMMU 116. Once these fields are initialized, the IOMMU may directly share exactly the same page tables.

If software requires 64-bit processor virtual addresses to be identical to I/O virtual addresses, including negative addresses, software may configure the IOMMU 116 with the 6-level paging structure illustrated in FIG. 3. An IOMMU device table entry 302 points to a page table 304. Each device table entry may specify different I/O page tables, or different device table entries may share the same I/O page tables.

The device table entry 302 may include a pointer to page table 304. The device tables 126 include device table entries. In one embodiment of the present invention, a device table entry is extended to include optional address translation information for guest-virtual-to-guest-physical address translation managed by the guest operating system. This allows for advanced computation architectures in virtualized systems such as compute-offload, user-level I/O, and accelerated I/O devices. When supported, two-level translation may be activated by programming the appropriate device table entries. The IOMMU automatically walks address translation tables based on control bits set by the system software.

The device table entry 302 may also include a domain identifier. The domain identifier acts as an address space identifier, allowing multiple devices sharing the same I/O page tables to share the same translation cache resources on the IOMMU. The domain identifier is the same for all devices that share the same page tables.

In FIG. 3, the 4K byte page table 304 at level 6, page table 306 at level 5, and page tables 308 and 310 at level 4 are used solely by the IOMMU. A CPU register CR3 320 refers to a page table 322. Page table 322 is used solely by the CPU. Sharing of processor page tables 330 and 340 between the IOMMU and CPU occurs only at levels 3 and below. Accordingly, both the IOMMU and CPU may access page tables 330 and 340. One skilled in the art can understand how future CPU embodiments can be extended that will use same page tables (304, 306, 308 and 310) as the IOMMU in FIG. 3.

Page tables 330 and 340 may include, for example, guest address translations (e.g., GPA to SPA) described in FIG. 2. Page tables 330 and 340 may also include one or more memory attributes of a page in system memory. The host or GPA-to-SPA page tables can be shared between the CPU 102 and the IOMMU 116. Accordingly, the one or more memory attributes of a page is exposed to both the CPU 102 and the I/O device 154 via the IOMMU 116.

In exemplary long mode level 4 page tables, the bottom 256 entries of the root page table correspond to positive virtual addresses with bits [63:47] all 0s, and the top 256 entries correspond to negative virtual addresses with bits [63:47] all 1s.

Specific memory regions may be associated with memory type information. For example, memory may be associated with cacheability information specified on a page granularity.

In one example, the CPU 102 implements different caching policies on a page depending on a memory type of the page. Based on the cacheability characteristic, the CPU 102 determines how to treat that memory from a caching perspective.

It may be undesirable to invoke cache coherency across the system because of the overhead involved in, for example, probes. For example, it may be desirable for physical pages to be configured by the page tables to allow read-only access. This prevents applications from altering the pages and ensures their integrity for use by all applications. Further, the system-software portion of the address space includes system-only data areas that must be protected from accesses by applications. System software uses the page tables to protect this memory by designating the pages as supervisor pages. Such pages are only accessible by system software.

In another example, if the CPU 102 communicates with registers of a device (e.g., network device or storage device), it may be undesirable to cache the regions of memory associated with that communication because it may result in improper operation. As a result, those regions of memory may be specified as non-cacheable.

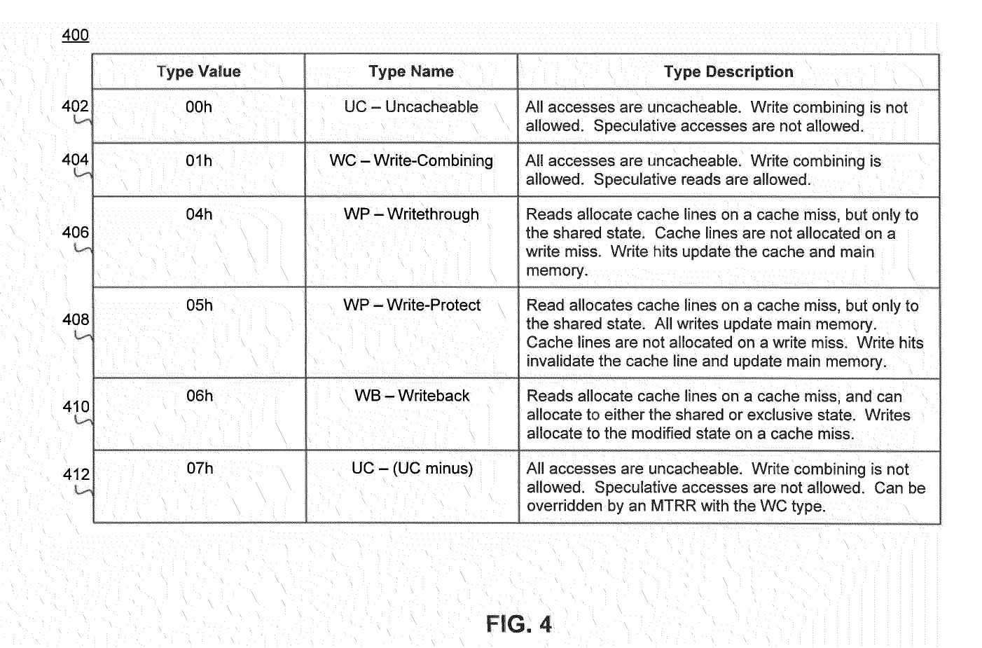

FIG. 4 is an illustration of a table 400 including cacheability characteristics in accordance with an embodiment of the present invention. Table 400 includes type value, type name, and type description information. The type value may signify a memory attribute of a page in computer system memory.

For example, a type value 402 has a value of 00h. Type value 402 may signify that a memory attribute of the page is uncacheable (UC). Reads from, and writes to, UC memory are not cacheable. Accordingly, the GPU will not cache the page. Reads from UC memory cannot be speculative, write-combining to UC memory is not allowed, and reads from or writes to UC memory cause the write buffers to be written to memory and be invalidated prior to the access to UC memory. The uC memory type is useful for memory-mapped I/O devices where strict ordering of reads and writes is important.

A type value 404 has a value of 01h. Type value 404 may signify that a memory attribute of the page is write-combining (WC). Reads from, and writes to, WC memory are not cacheable, and reads from WC memory can be speculative. Further, writes to this memory type can be combined internally by the processor and written to memory as a single write operation to reduce the number of memory accesses. For example, four word writes to consecutive addresses can be combined by the processor into a single quadword write, resulting in one memory access instead of four. The WC memory type is useful for graphics-display memory buffers where the order of writes is not important.

A type value 406 has a value of 04h. Type value 406 may signify that a memory attribute of the page is write-through (WT). Reads from WT memory are cacheable and allocate cache lines on a read miss. Further, reads from WT memory can be speculative. Additionally, all writes to WT memory update main memory, and writes that hit in the cache update the cache line (cache lines remain in the same state after a write that hits a cache line). Writes that miss the cache do not allocate a cache line, and write buffering of WT memory is allowed.

A type value 408 has value of 05h. Type value 408 may signify that a memory attribute of the page is write-protect (WP). Reads from WP memory are cacheable and allocate cache lines on a read miss. Further, reads from WP memory can be speculative. Additionally, writes to WP memory that hit in the cache do not update the cache. Instead, all writes update memory (write to memory), and writes that hit in the cache invalidate the cache line. Write buffering of WP memory is allowed, and the WP memory type is useful for shadowed-ROM memory where updates must be immediately visible to all devices that read the shadow locations. Using caches to store frequently used data can result in significantly improved software performance by avoiding accesses to the slower main memory.

A type value 410 has value of 06h. Type value 410 may signify that a memory attribute of the page is write-back (WB). Reads from WB memory are cacheable and allocate cache lines on a read miss. Cache lines can be allocated in the shared, exclusive, or modified states. Further, reads from WB memory can be speculative. Additionally, all writes that hit in the cache update the cache line and place the cache line in the modified state. Writes that miss the cache allocate a new cache line and place the cache line in the modified state, writes to main memory only take place during writeback operations, and write buffering of WB memory is allowed. The WB memory type provides the highest-possible performance and is useful for most software and data stored in system memory (DRAM).

A type value 412 has value of 07h. Type value 412 may signify that a memory attribute of the page is uncacheable minus (UC minus). Reads from, and writes to, UC memory are not cacheable. Further, write-combining to UC memory is not allowed. Additionally, type value 412 can be overridden by memory-type range registers (MTRRs) (described below) with the WC type. UC minus is generally defined as same as Uncacheable but can be overridden by MTRRs.

he above example memory attributes are not intended to be limiting. A person of skill in the relevant art(s), however, will appreciate that a page may be associated with other attributes. Accordingly, other attributes are also within the spirit and scope of the present invention.

The page tables shared between the CPU 102 and the I/O device 154 may include address translation information, permission information, and caching characteristics. Consequently, the IOMMU 116 may access the cacheability information of a page in system memory and can provide that information to the I/O device 154. Accordingly, the I/O device 154 may be exposed to the cacheability characteristics of a page and may implement the caching policy associated with the page.

The shared or non-shared status of the memory page can change. For example, information on a page that is not shared may be described to the I/O device 154. After time passes, the page may be shared with the CPU 102. At a later point in time, the page may be removed from sharing. The system software may provide updates on the status of the pages. In one embodiment, the page in system memory is located at a shared memory address space of the CPU 102 and the I/O device 154. In another embodiment, the page in system memory is not located at a shared memory address space of the CPU 102 and the I/O device 154.

In one embodiment, the IOMMU 116 receives a request from, for example, I/O device 154 to translate a virtual address to a physical address to access a page in system memory. The IOMMU 116 translates the address using a translation table shared with the CPU 102. The IOMMU 116 sends a response to the I/O device 154 that includes the physical address. In addition, the IOMMU 116 may identify cacheability characteristics of the page from the page table and also include the cacheability characteristics of the page in the response to the I/O device 154. The cacheability characteristic of the page may include the identified one or more memory attributes of the page.

In one embodiment, the cacheability characteristic of a page can be transformed into a caching attribute that is used by the I/O device 154. For example, the IOMMU 116 may map the one or more memory attributes of the page to a caching attribute. In this embodiment, the IOMMU 116 performs the transformation instead of I/O device 154. In this way, the complexity of the transformation may be moved from the I/O device 154 to the IOMMU where it is done once (instead of done for all I/O devices). The caching attribute may be a Boolean value (e.g., a yes/no value).

In one embodiment of the present invention, an IOMMU MMIO register including a number of subfields is added to the IOMMU. The number of subfields may depend on the possible values of the caching characteristics. In one embodiment of the present invention, one subfield for every possible value of the caching characteristics is added to the IOMMU. For example, if the caching characteristics field occupies 3 bits, eight distinct values may be possible and the added IOMMU MMIO register may include eight subfields. The cacheability characteristic of the page may include only the caching attribute.

In one embodiment, the cacheability characteristic of the page includes both the identified one or more memory attributes of the page and the caching attribute. In this embodiment, the IOMMU may send a translation response to I/O device 154 that includes the actual caching characteristic (e.g., 3 bits) and the caching attribute (e.g., 1-bit).

Attributes of a page may be determined in a variety of ways. For example, in one embodiment, MTRRs control cacheability based on physical addresses. The MTRR mechanism provides system software with the ability to manage hardware-device memory mapping. System software can characterize physical-memory regions by type (e.g., ROM, flash, memory-mapped I/O) and assign hardware devices to the appropriate physical-memory type. The MTRR mechanism provides a means for associating a physical-address range with a memory type. The MTRRs contain a type field used to specify the memory type in effect for a given physical-address range.

In another embodiment, the page-attribute table (PAT) mechanism controls cacheability based on virtual addresses. Like the MTRRs, PAT provides system software with the ability to manage hardware-device memory mapping. With PAT, however, system software can characterize physical pages individually and assign virtually-mapped devices to those physical pages using the page-translation mechanism. The PAT mechanism extends the page-table entry format, providing the same memory-typing capabilities as the MTRRs but with the added flexibility of the paging.

In another embodiment, PAT may be used in conjunction with the MTTR mechanism to maximize flexibility in memory control.

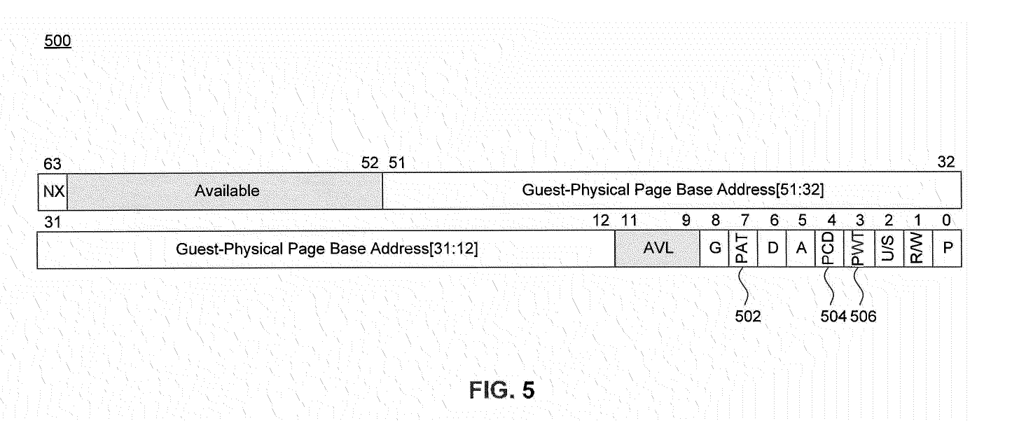

FIG. 5 is an illustration of a 4-Kbyte page table entry format 500 including memory attribute information in accordance with an embodiment of the present invention. The page table entry format 500 includes PAT bit 502. The PAT bit 502 specifies to the CPU or IOMMU the caching policy associated with a page in computer system memory.

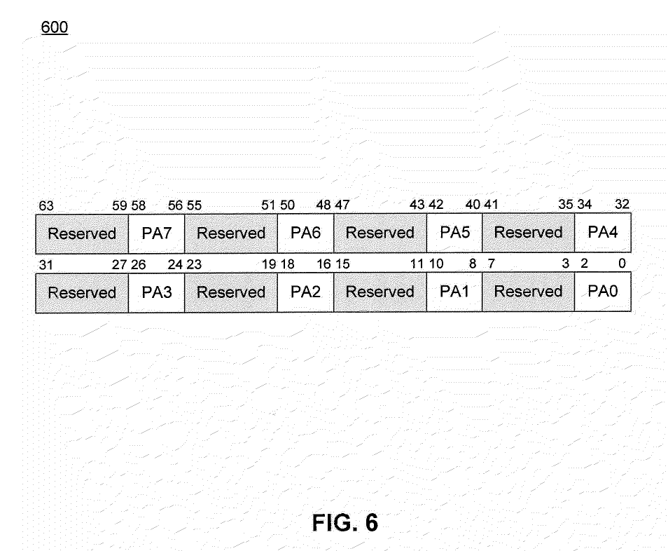

Page table entry format 500 also includes a PCD (page cache disable) bit 504 and a PWT (page write-through) bit 506. These bits are described below with respect to FIG. 6.

FIG. 6 is an illustration of a PAT register format 600 in accordance with an embodiment of the present invention. Page attribute fields in the PAT register are selected using three bits from the page-table entries (e.g., page table entry format 500).

For example, the PAT bit 502 in FIG. 5 may be the high-order bit of a 3-bit index into the PAT register. The PAT bit 502 occupies bit 7 in FIG. 5 and may be present in the lowest level of the page-translation hierarchy. Page-table entries that do not have a PAT bit (e.g., PML4 entries) may assume PAT=0.

The other two bits involved in forming the index may be the PCD and PWT bits. The PCD bit 504 occupies bit 4 in the example page table entry of FIG. 5. The PCD bit 504 from the PTE or PDE may be selected depending on the paging mode. The PWT bit 506 occupies bit 3 in the example page table entry of FIG. 5. The PWT bit 506 from the PTE or PDE may be selected depending on the paging mode.

In FIG. 6, the PAT register contains eight page-attribute (PA) fields, numbered from PA0 to PA7. The PA fields hold the encoding of a memory attribute. Software can write any supported memory-type encoding into any of the eight PA fields. An attempt to write anything but zeros into the reserved fields may cause a general-protection exception (#GP). An attempt to write an unsupported type encoding into a PA field may also cause a #GP exception.

As described, the IOMMU is allowed to cache page table and device table contents to speed translations. Each page table can also have its contents cached by the IOMMU or peripheral IOTLBs. Therefore, after updating a table entry that can be cached, system software sends the IOMMU an appropriate invalidate command. Information in the peripheral IOTLBs is also invalidated. The IOMMU may support hardware updates of Accessed and Dirty bits in guest page tables. The IOMMU may cache these bits, so software issues invalidation commands when it clears the bits in memory.

The IOMMU updates the guest page table Accessed and Dirty bits in a manner compatible with the processor. For example, the IOMMU may implement the equivalent of a locked-OR. Specifically, the IOMMU sets the Accessed bit in a locked operation, and sets the Accessed and Dirty bits in a single locked operation. In one embodiment of the present invention, the IOMMU does not clear the Accessed or Dirty bits; software is responsible to clear the bits. The IOMMU may cache these bits. Accordingly, the software may issue invalidation commands when it clears the bits in PTE.

TLB-management instructions are used to maintain coherency between page translations cached in the TLB and the translation tables maintained by system software in memory translations. This creates a framework for creating scalable systems with an IOMMU in which I/O devices may have different usage models and working set sizes. IOTLB-capable I/O devices contain private TLBs tailored for their own needs, creating a scalable distributed system of TLBs. The performance of IOTLB-capable I/O devices may not be limited by the number of TLB entries implemented in the IOMMU. A peripheral with an IOTLB may issue un-translated addresses or pre-translated addresses that are determined from IOTLB entries. Pre-translated addresses may not be checked by the IOMMU except to validate that the peripheral has the IOTLB enable bit set (I=1) in the corresponding device table entry.

The IOMMU may include optional support for peripheral page service requests (PPR) for peripherals that use ATS. This may include a mechanism for peripherals and software to reduce the need for pinned pages during I/O. The IOMMU may include optional support for interrupt virtualization. This may use a virtualized guest APIC with memory tables to deliver interrupts to guest VMs. For example, the PREFETCH_IOMMU_PAGES command is a hint to the IOMMU that the associated translation records will be needed relatively soon and that the IOMMU should execute a page table walk to load the translation information. Based on internal status and workloads, the IOMMU may fetch the translation information into a TLB. If an entry is already in the TLB, the IOMMU may adjust a scheduling algorithm (e.g., least recently used) or other control tags to lengthen cache residency.

When the IOMMU detects an access violation based on cached information, it may discard the information in the IOMMU TLB and reload the translation information from memory. Further, the peripheral can use address translation information from the IOTLB or obtained via ATS to deter-nine access privileges for a nested (hosted) access. A peripheral with an IOTLB may invalidate a cached entry causing an insufficient-privilege failure when R=1 or W=1 in the IOTLB entry for a guest access. The peripheral may then request the guest translation information using ATS and retry the access. If the revised privileges are insufficient for the retry, the peripheral may take appropriate action to abandon the access or issue a PCIe PRI request for escalated privileges.

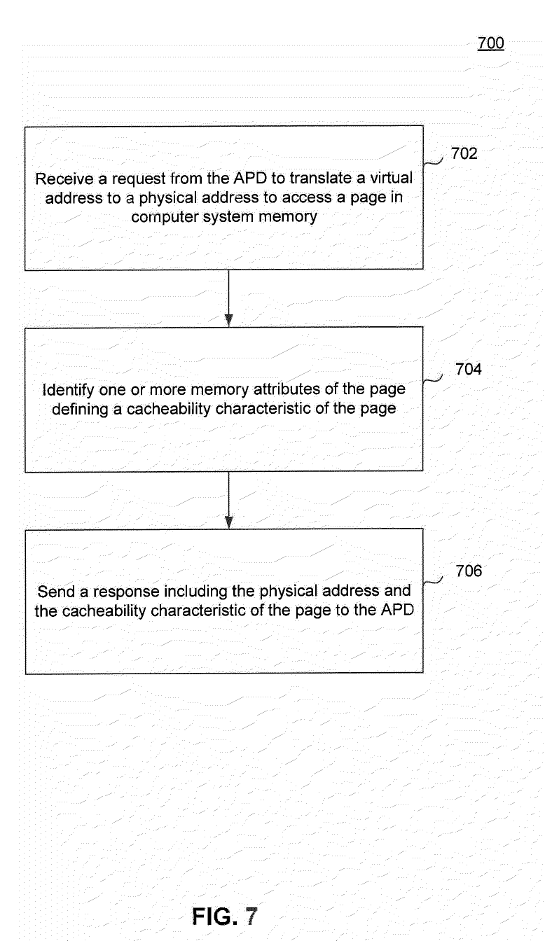

FIG. 7 is an illustration of an exemplary method 700 of practicing an embodiment of the present invention. In method 700, step 702 illustrates receiving a request from the APD to translate a virtual address to a physical address to access the page in system memory.

Step 704 illustrates identifying one or more memory attributes of the page defining a cacheability characteristic of the page. Examples of memory attributes are uncacheable, uncacheable minus, write-combining, write-protect, write-through, and write-back.

Step 706 illustrates sending a response including the physical address and the cacheability characteristic of the page to the APD. The cacheability characteristic of the page may include the identified one or more memory attributes of the page, a caching attribute of the page, or a combination of these.

In an embodiment, IOMMU 116 performs steps 702, 704 and 706.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method comprising:
receiving a request from an APD to translate a virtual address to a physical address to access a page in a memory; and
sending a response including the physical address and cacheability characteristic of the page to the APD.

2. The method of claim 1, further comprising:
identifying one or more memory attributes of the page defining one or more cacheability characteristics of the page.

3. The method of claim 2, wherein the cacheability characteristic of the page further includes the identified one or more memory attributes of the page.

4. The method of claim 2, further comprising mapping the one or more memory attributes of the page to a caching attribute, wherein the cacheability characteristic of the page includes the caching attribute.

5. The method of claim 4, wherein the caching attribute comprises a Boolean value.

6. The method of claim 1, further comprising modifying the cacheability characteristic of the page in response to the request to modify the cacheability characteristic.

7. The method of claim 2, wherein a memory attribute of the page is at least one of: uncacheable, uncacheable minus, write-combining, write-protected, write-through and write-back.

8. The method of claim 2, wherein the memory attributes of the page are encoded in page-attribute fields.

9. The method of claim 1, wherein the page in system memory is located at a shared memory address space of a central processing unit (CPU) and the APD.

10. The method of claim 1, wherein the page in system memory is not located at a shared memory address space of a central processing unit (CPU) and the APD.

11. An apparatus having computer program logic recorded thereon, execution of which, by a computing device, causes the computing device to perform operations comprising:
receiving a request from an accelerated processing device (APD) to translate a virtual address to a physical address to access a page in computer system memory; and
sending a response including the physical address and cacheability characteristic of the page to the APD.

12. The apparatus of claim 11, further comprising:
identifying one or more memory attributes of the page defining one or more cacheability characteristics of the page; and

13. The apparatus of claim 12, wherein the cacheability characteristic of the page includes the identified one or more memory attributes of the page.

14. The apparatus of claim 12, wherein the IOMMU is further configured to map the one or more memory attributes of the page to a caching attribute, wherein the cacheability characteristic of the page includes the caching attribute.

15. The apparatus of claim 14, wherein the caching attribute comprises a Boolean value.

16. The apparatus of claim 11, wherein the IOMMU is further configured to:
receive a request from the APD to modify the cacheability characteristic of the page; and
modify the cacheability characteristic of the page in response to the request to modify the cacheability characteristic.

17. The apparatus of claim 12, wherein a memory attribute of the page is at least one of: uncacheable, uncacheable minus, write-combining, write-protected, write-through and write-back.

18. The apparatus of claim 12, wherein the memory attributes of the page are encoded in page-attribute fields.
